(19) United States
(12) Patent Application Publication
(10) Pub. No.: US 2017/0212307 A1
(43) Pub. Date: Jul. 27, 2017

(54) Optical Coupling Using Plastic Optical Fiber

(71) Applicant: Jia Jiang, Kanata (CA)

(72) Inventor: Jia Jiang, Kanata (CA)

(21) Appl. No.: 15/003,510

(22) Filed: Jan. 21, 2016

(51) Int. Cl. G02B 6/30; G02B 6/36; G02B 6/44; G02B 6/02; G02B 6/34

(52) U.S. Cl. CPC G02B 6/30; G02B 6/02033; G02B 6/34; G02B 6/4403; G02B 6/3652; G02B 6/3672

(57) ABSTRACT

An optical coupler has a plastic optical fiber and a curved support member for mechanically supporting the plastic optical fiber at a predetermined bend radius. The plastic optical fiber can be made of perfluorinated polymer. The plastic optical fiber can be curved at a bend radius of less than 10 mm. This enables compact packaging of the coupler.

### TECHNICAL FIELD

The present disclosure relates generally to optical telecommunications and, more particularly, to optical couplers for interfacing optical fibers with photonic integrated circuits.

### BACKGROUND

A photonic integrated circuit (PIC) built on silicon-on-insulator (SOI) platform is very compact and exhibits a high level of functional integration. This technology promises advantages in terms of speed, compactness and low cost. To implement the SOI photonic chip, a large quantity of optical signals must be transmitted into and out of the chip. Surface grating couplers (SCG) on the silicon chip interface with optical fibers to perform input/output functions. A surface grating coupler (SGC) is designed and fabricated on the silicon chip to couple light from the optical fiber to the PIC chip, or in reverse. The SGC transmits the incident optical beam at an angle to the chip surface. The SGC comprises a diffraction grating and a waveguide in the plane of the chip. The grating diffracts the incident beam into the waveguide. The SGC can also work in reverse as an optical output coupler. As the incident angle affects significantly the first mode diffraction, a high coupling efficiency can only be achieved by assiduously preserving the precision of the incident angle. Hence, the precise packaging of the optical fiber and PIC is required. However, this task is challenging because the optical fiber must be packaged vertically (or close to vertically) with respect to the chip plane, depending on the incident angle of the light beam. In most cases, silica fiber is used for fiber-to-chip packaging. The silica fiber is positioned vertically, or close to vertically, relative to the PIC chip. The fiber is bent or curved to permit the tail to extend out of the packaging. However, silica fiber has little tolerance to bending. Its bending radius is limited by optical loss and mechanical durability. Because of its large bending radius, silica fiber requires a large space to bend 90 degrees. Furthermore, silica fiber is easily broken during or after the packaging process. Use of silica fiber therefore limits the coupling quality, compactness and cost.

An improved optical coupler is therefore highly desirable.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

The present specification discloses an optical coupler, such as a silicon grating coupler, that has one or more plastic optical fibers bent over a curved mechanical support. The plastic optical fiber has a significantly smaller bend radius than silica fibers, thus enabling more compact packaging. The plastic optical fiber is also more resistant to thermal strain at the joint of fiber to silicon chip because the adhesive used to adhere the plastic optical fiber to the photonic integrated circuit is a polymer glue having a thermal expansion coefficient identical, or at least very similar, to that of the plastic optical fiber.

One inventive aspect of the disclosure is an optical coupler that has a plastic optical fiber and a curved support member for mechanically supporting the plastic optical fiber at a predetermined bend radius. The plastic optical fiber can be made of perfluorinated polymer which is a category of low-loss optical polymer. The plastic optical fiber can be curved at a bend radius of less than 10 mm (0.4 inches). The plastic optical fiber may be packaged as part of a ribbon of fibers or a two-dimensional array of fibers. This optical coupler is compact and more resistant to thermal strain.

Another inventive aspect of the disclosure is a method of coupling an optical fiber to a photonic integrated circuit. The method entails bending a plastic optical fiber over a curved support member that mechanically supports the plastic optical fiber at a predetermined bend radius and adhering the plastic optical fiber to the photonic integrated circuit.

### BRIEF DESCRIPTION OF THE DRAWINGS

These and other features of the disclosure will become more apparent from the description in which reference is made to the following appended drawings.

FIG. 1 is a top view of an optical coupler having a plastic optical fiber (POF) array ribbon in accordance with an embodiment of the present disclosure.

FIG. 2 is a side view of the optical coupler of FIG. 1 coupled to a photonic integrated circuit (PIC).

FIG. 3 is an enlarged side view of the interface between the optical coupler and the PIC.

FIG. 4 is an isometric view of a two-dimensional POF array in accordance with another embodiment of the present disclosure.

### DETAILED DESCRIPTION OF EMBODIMENTS

The following detailed description contains, for the purposes of explanation, numerous specific embodiments, implementations, examples and details in order to provide a thorough understanding of the invention. It is apparent, however, that the embodiments may be practiced without these specific details or with an equivalent arrangement. In other instances, some well-known structures and devices are shown in block diagram form in order to avoid unnecessarily obscuring the embodiments of the invention. The description should in no way be limited to the illustrative implementations, drawings, and techniques illustrated below, including the exemplary designs and implementations illustrated and described herein, but may be modified within the scope of the appended claims along with their full scope of equivalents.

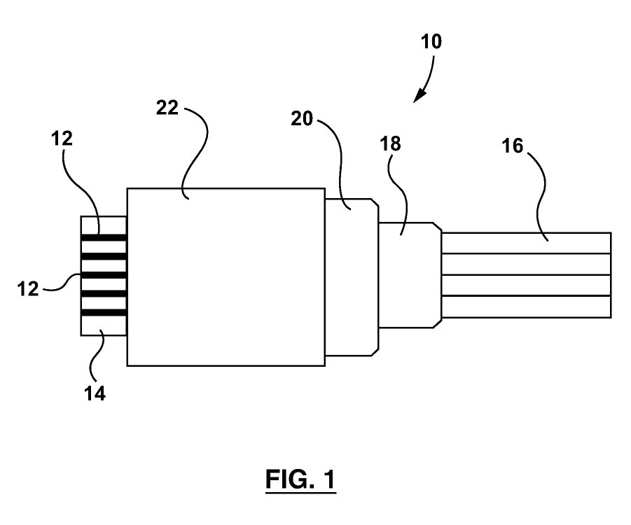

In the embodiment illustrated by way of example in FIG. 1, and as will be described below in greater detail, a novel optical coupler 10 has a plurality of plastic optical fibers 12. In the embodiment depicted in FIG. 1, each plastic optical fiber (POF) 12 is packaged in a side-by-side arrangement to form a fiber ribbon 14. As will be explained below in greater detail, each POF 12 is made of a polymer that is capable of bending sharply, i.e. able to bend over a small radius of curvature. At least one POF 12 may be provided. In one embodiment, the plastic optical fiber(s) 12 is/are made of perfluorinated polymer. Perfluorinated fiber has a relatively flat spectrum which makes it best suited for use with wavelengths such as 650 nm, 850 nm, 1310 nm, and 1490 nm.

In the embodiment depicted by way of example in FIG. 1, the optical coupler 10 has a POF pigtail 16. The fiber ribbon 14 is designed to interface with a photonic integrated circuit (PIC) whereas the pigtail 16 is designed to interface with one or more optical fibers, e.g. silica fibers.

In the embodiment depicted by way of example in FIG. 1, the optical coupler 10 has a curved support member 18 for mechanically supporting each POF 12 at a predetermined bend radius. The curved support member 18 is a rigid component made of plastic, metal, composite material or any other suitable material or combination of materials. The curved support member 18 may be held by, or encapsulated within, one or more exterior support structures, i.e. underside support structure 20 and topside support structure 22. These support structures are designed to hold the POF ribbon 14 firmly against the curved support member 18. These support structures also provide an enlarged bottom surface to adhere to the PIC.

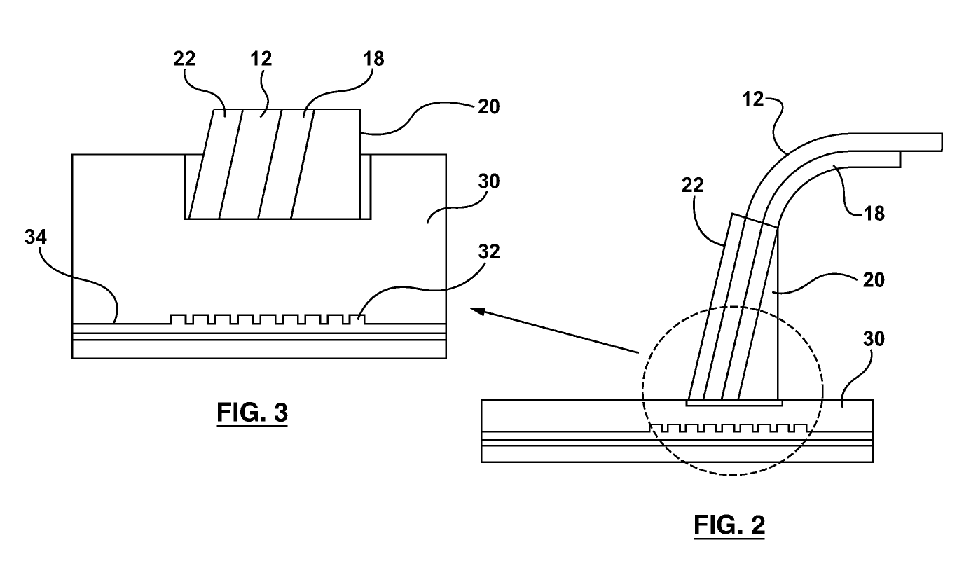

FIGS. 2 and 3 are, respectively, a side view and an enlarged side view of the optical coupler 10 of FIG. 1, showing the bend of the POF 12. A plurality of plastic optical fibers 12 are packaged side-by-side as the POF ribbon 14 (FIG. 1). The curved support member 18 mechanically supports the POF 12 or the ribbon 14 fibers at a predetermined bend radius.

The optical coupler 10 is shown interfaced or coupled to a photonic integrated circuit (PIC) 30. As illustrated in this particular example, the optical coupler 10 is coupled to a grating 32 such as, for example, a silicon grating coupler (SCG). The SCG in the figure is connected to an optical waveguide 34.

In the embodiment depicted in FIGS. 2 and 3, the plastic optical fiber 12 can be curved at a bend radius of less than 10 mm (0.4 inches). The bend radius of the POF 12 may be a constant radius or a varying radius. Alternatively, the POF 12 may have a constant radius over a certain portion and a varying radius over another portion. A bend radius as low as 5 mm (0.2 inches) can be achieved for some applications. These tight bend radii enable much more compact packaging than what can be achieved with a silica-based coupler.

The plastic optical fibers 12 of the ribbon 14 along with support member 18 and support structures 20, 22 adhere to the PIC 30 by a polymer glue (i.e. polymer adhesive such as a thermally curable or UV curable epoxy, a polymer-based bond material, etc.) that has a same or similar thermal expansion coefficient as the plastic optical fibers 12 to thereby minimize or lessen thermally induced strain. The support structures 20, 22 may be a single support structure in another embodiment.

In the embodiments depicted in FIGS. 1, 2, and 3, the plastic optical fiber 12 could be, for example, a perfluorinated polymer-based plastic fiber. Perfluorinated fibers are much more affordable than other high-performance fiber types such as glass. The optical coupler 10 with a plastic optical fiber is capable of efficiently coupling light on/off a silicon photonic chip, providing a high-speed and low-cost solution. This optical coupler 10 may be used in an optical modulator, photonic switch or any other device which requires that an optical signal be coupled in and out of the photonic chip. This coupler is best suited to work in the range of wavelengths from visible to 1310 nm or further longer wavelength. For wavelengths longer than 1310 nm, the POF 12 works are well suited for cases that do not impose strict requirements in terms of optical loss. The plastic optical fiber 12 may be positioned vertically, or nearly vertically, on the grating coupler on the silicon chip. The plastic optical fiber 12 is maintained precisely at the desired incident angle to maximize coupling efficiency. The curved support member 18 has a upper curved portion (or “curve”) which can be made as small as the minimum bend radius of the plastic optical fiber 12, e.g. less than 10 mm (0.4 inches) and, in some instances, as low as 5 mm (0.2 inches). The support member 18 maintains the angle of the plastic optical fiber 12 relative to the plane of the chip. Although the curve may be as small as the minimum bend radius, a large radius may be used to allow the plastic optical fiber 12 to bend more easily bent from the generally vertical direction to a horizontal direction. As noted above, the plastic fiber pigtail may extend to an exterior of the chip package box in the generally horizontal direction. Standard fiber connectors could be used to connect each plastic optical fiber 12 to another kind of fiber such as a silica fiber.

In other embodiments, the plastic optical fiber 12 could be designed in various mode sizes by tailoring the core/cladding index contrast ratio in order to maximize the efficiency of the grating coupler 32.

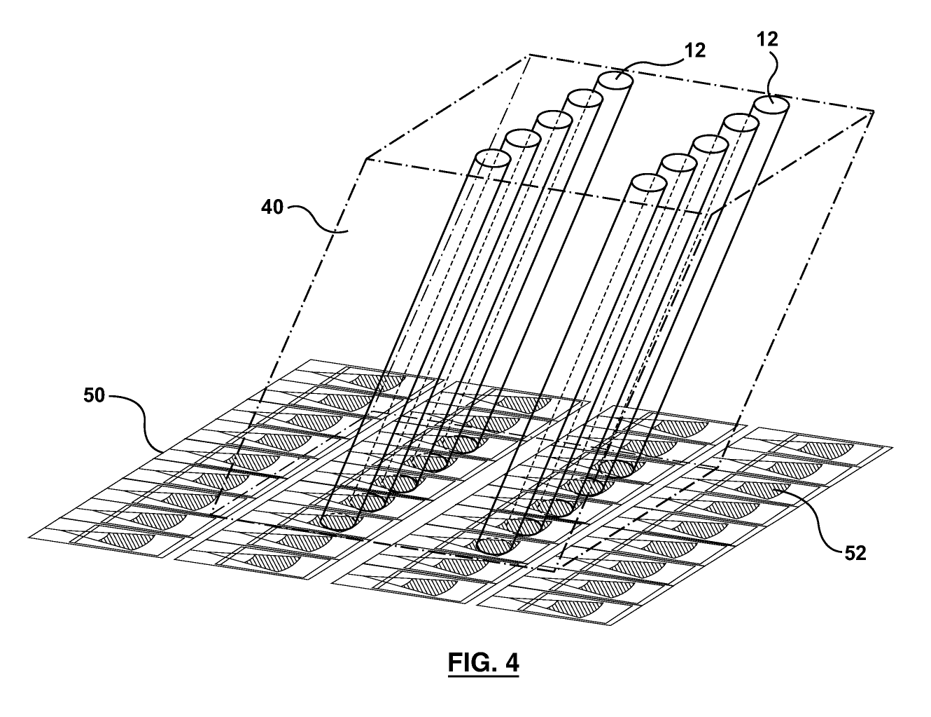

In the embodiment illustrated by way of example in FIG. 4, a plurality of plastic optical fibers 12 are packaged in a two-dimensional array. The array may dispose the plastic optical fibers 12 in equally spaced rows and columns within a holding body 40, or in any other suitable arrangement. A modified version of the curved support member 18 mechanically supports the two-dimensional array of plastic optical fibers 12 as these bend. In one embodiment, the fibers of the array are all bent at a common predetermined bend radius. As depicted in FIG. 4, the plastic optical fibers 12 and the holding body 40 are bonded to a photonic integrated circuit 50 so as to couple the fibers 12 with respective optical elements 52, e.g. silicon grating couplers or other I/O devices, that are disposed on the top surface of the PIC 50. The plastic optical fibers 12 are glued on the surface of the PIC 50 by a polymer glue having similar thermal expansion coefficient and similar surface tension, thus providing better long term stability than that of silica fiber.

Another inventive aspect disclosed herein is a method of coupling an optical fiber to a photonic integrated circuit. The method entails bending a plastic optical fiber, e.g. the POF 12, over a curved support member, e.g. the curved support member 18, that mechanically supports the plastic optical fiber at a predetermined bend radius and adhering the plastic optical fiber to the photonic integrated circuit. In one implementation, adhering the plastic optical fiber to the photonic integrated circuit entails using a polymer glue that has a same thermal expansion coefficient as the plastic optical fiber to thereby minimize thermally induced strain. In one implementation, bending the plastic optical fiber entails bending the plastic optical fiber to a bend radius of less than 10 mm (0.4 inches). In one implementation, the method is used to couple the plastic optical fiber at a predetermined angled with a silicon grating coupler. This method enables compact packaging of fiber-to-PIC couplings. As noted above, plastic optical fiber provides significant advantages over silica fiber in terms of bending radius. The bend radius of a plastic optical fiber is usually one order of magnitude better than that of silica fiber. The larger tolerance for bending not only enables more compact packaging but also means that the plastic optical fiber is less susceptible to thermal strain and fatigue than silica fiber. Furthermore, plastic optical fiber is less susceptible to crosstalk than silica fiber.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including”, “entailing” and “containing”, or verb tense variants thereof, are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the inventive concept(s) disclosed herein.

1. An optical coupler comprising:
a plastic optical fiber; and
a curved support member for mechanically supporting the plastic optical fiber at a predetermined bend radius.

2. The optical coupler of claim 1 wherein the plastic optical fiber is made of perfluorinated polymer.

3. The optical coupler of claim 2 wherein the plastic optical fiber is curved at a bend radius of less than 10 mm.

4. The optical coupler of claim 1 wherein the plastic optical fiber adheres to a photonic integrated circuit by a polymer glue that has substantially a same thermal expansion coefficient as the plastic optical fiber to thereby lessen thermally induced strain.

5. The optical coupler of claim 1 further comprising a silicon grating coupler, wherein the plastic optical fiber is angled to couple with the silicon grating coupler.

6. The optical coupler of claim 1 comprising a plurality of plastic optical fibers packaged side-by-side as a fiber ribbon and wherein the curved support member mechanically supports the ribbon of plastic optical fibers at a common predetermined bend radius.

7. The optical coupler of claim 1 comprising a plurality of plastic optical fibers packaged in a two-dimensional array and wherein the curved support member mechanically supports the two-dimensional array of plastic optical fibers at a common predetermined bend radius.

8. The optical coupler of claim 2 comprising a plurality of plastic optical fibers packaged side-by-side as a fiber ribbon and wherein the curved support member mechanically supports the ribbon of plastic optical fibers at a common predetermined bend radius.

9. The optical coupler of claim 2 comprising a plurality of plastic optical fibers packaged in a two-dimensional array and wherein the curved support member mechanically supports the two-dimensional array of plastic optical fibers at a common predetermined bend radius.

10. The optical coupler of claim 8 wherein the plastic optical fibers are curved at a bend radius of less than 10 mm.

11. The optical coupler of claim 9 wherein the plastic optical fibers are curved at a bend radius of less than 10 mm.

12. The optical coupler of claim 10 further comprising a photonic integrated circuit, wherein the plastic optical fibers adhere to the photonic integrated circuit by a polymer glue that has substantially a same thermal expansion coefficient as the plastic optical fibers to thereby lessen thermally induced strain.

13. The optical coupler of claim 11 further comprising a photonic integrated circuit, wherein the plastic optical fibers adhere to the photonic integrated circuit by a polymer glue that has substantially a same thermal expansion coefficient as the plastic optical fibers to thereby lessen thermally induced strain.

14. The optical coupler of claim 12 further comprising a silicon grating coupler, wherein the plastic optical fiber is angled to couple with the silicon grating coupler.

15. The optical coupler of claim 13 further comprising a silicon grating coupler, wherein the plastic optical fiber is angled to couple with the silicon grating coupler.

16. The optical coupler of claim 13 further comprising a silicon grating coupler and a silica fiber, wherein the plastic optical fiber has one end coupled with the silicon grating coupler and another end coupled with the silica fiber.

17. A method of coupling an optical fiber to a photonic integrated circuit, the method comprising:
bending a plastic optical fiber over a curved support member that mechanically supports the plastic optical fiber at a predetermined bend radius; and
adhering the plastic optical fiber to the photonic integrated circuit.

18. The method of claim 17 wherein adhering the plastic optical fiber to the photonic integrated circuit comprises using a polymer glue that has substantially a same thermal expansion coefficient as the plastic optical fiber to thereby lessen thermally induced strain.

19. The method of claim 17 wherein bending the plastic optical fiber comprises bending the plastic optical fiber to a bend radius of less than 10 mm.

20. The method of claim 17 wherein the plastic optical fiber is angled to couple with a silicon grating coupler.
